(19) United States
(12) Patent Application Publication
(10) Pub. No.: US 2015/0113928 A1
(43) Pub. Date: Apr. 30, 2015

(54) DUAL AIR SOURCE AUTOMOTIVE AIR FILTER SYSTEMS

(71) Applicant: Green Filter USA, Inc., Mt. Braddock, PA (US)

(72) Inventors: Mark K. German, Pittsburgh, PA (US); Daniel J. Sumey, Uniontown, PA (US)

(21) Appl. No.: 14/525,819

(22) Filed: Oct. 28, 2014

Related U.S. Application Data
(60) Provisional application No. 61/897,314, filed on Oct. 30, 2013.

(51) Int. Cl. F02M 35/024; F02M 35/02

(52) U.S. Cl. CPC F02M 35/02416; F02M 35/0212
USPC 55/482; 29/428

(57) ABSTRACT

Dual air source automotive air filter systems are disclosed. The dual source automotive filter includes an outer filter, an inner filter at least partially inside the outer filter defining a combined airstream volume between an interior side of the outer filter and an exterior side of the inner filter, an external air source inlet in flow communication with an interior volume of the inner filter, and a combined airstream outlet in flow communication with the combined airstream volume. The system may include a housing in which the filter is installed. A method of installing the dual source automotive filter system in a vehicle is also disclosed.

### CROSS-REFERENCE TO RELATED APPLICATION

This application claims the benefit of U.S. Provisional Patent Application Ser. No. 61/897,314 filed Oct. 30, 2013, which is incorporated herein by reference.

### FIELD OF THE INVENTION

The present invention relates to automotive air filter systems, and more particularly relates to dual air source automotive air filter systems.

### BACKGROUND INFORMATION

OEM vehicles such as trucks and cars typically have a standard closed box air filter system that pulls air from an OEM opening in the fender of the vehicle to get cold dense air into the engine. Alternatively, certain types of aftermarket air filter systems pull air from inside the engine compartment. Such aftermarket open air box systems typically include a cone style air filter that pulls air from under the hood, which may be at very high temperature.

### SUMMARY OF THE INVENTION

The dual air source filter system of the present invention may replace OEM closed systems with an open air box system that provides improved air flow for better performance and gas mileage. The dual air source filter system provides advantages over conventional aftermarket open air box systems by additionally pulling cold dense air from outside of the vehicle, e.g., through an OEM fender opening. The dual air source filter system provides improved performance while also generating the throaty sound of a performance engine.

An aspect of the present invention is to provide a dual source automotive air filter comprising an outer filter, an inner filter at least partially inside the outer filter defining a combined airstream volume between an interior side of the outer filter and an exterior side of the inner filter, an external air source inlet in flow communication with an interior volume of the inner filter, and a combined airstream outlet in flow communication with the combined airstream volume.

Another aspect of the present invention is to provide a dual source automotive air filter system comprising a housing structured and arranged for installation in an engine compartment of an automotive vehicle, and a dual source automotive air filter in the housing. The dual source air filter comprises an outer filter having an exterior side exposed to air in the engine compartment when installed in the vehicle, and an inner filter at least partially inside the outer filter defining a combined airstream volume between an interior side of the outer filter and an exterior side of the inner filter, an external air source inlet in flow communication with an interior volume of the inner filter, and a combined airstream outlet in flow communication with the combined airstream volume.

A further aspect of the present invention is to provide a method of installing a dual source automotive air filter system in an automotive vehicle. The method comprises connecting an air inlet of the dual source air filter system to a source of external air drawn from outside an engine compartment of the vehicle, and connecting an air outlet of the dual source air filter system to an engine air intake of the vehicle. The dual source automotive air filter system comprises a housing that is installed in the engine compartment of an automotive vehicle, and a dual source automotive air filter in the housing, which comprises an outer filter having an exterior side exposed to air in the engine compartment, and an inner filter at least partially inside the outer filter having an interior volume in flow communication with the source of external air.

These and other aspects of the present invention will be more apparent from the following description.

### BRIEF DESCRIPTION OF THE DRAWINGS

FIG. 1 is a flow diagram illustrating aspects of the present invention.

FIGS. 2 and 3 are isometric views of a dual air source automotive air filter system in accordance with an embodiment of the present invention.

FIG. 4 is a sectional view illustrating details of a dual source filter in accordance with an embodiment of the present invention.

### DETAILED DESCRIPTION

In accordance with embodiments of the present invention, dual source automotive air filter systems are provided that include an outer filter in communication with air in the engine compartment of the vehicle, and an inner filter in communication with an air source outside of the vehicle, i.e., air that is not drawn from inside the engine compartment. The outer filter may have any suitable shape, such as conical, pyramidal, round, square, rectangular, etc. The inner filter may also have any suitable shape, such as conical, pyramidal, etc., and may be reversed tapered. The outer filter pulls air from the engine compartment, i.e., from under the hood of the vehicle. The filter includes a cold air inlet opening and/or adapter on one end that allows cold dense air to be pulled in through the inner filter, e.g., utilizing the OEM factory opening as a true cold air supply. Thus, cold dense air may be pulled into the engine while also pulling air in from the engine compartment, giving the throaty sound of a high performance engine.

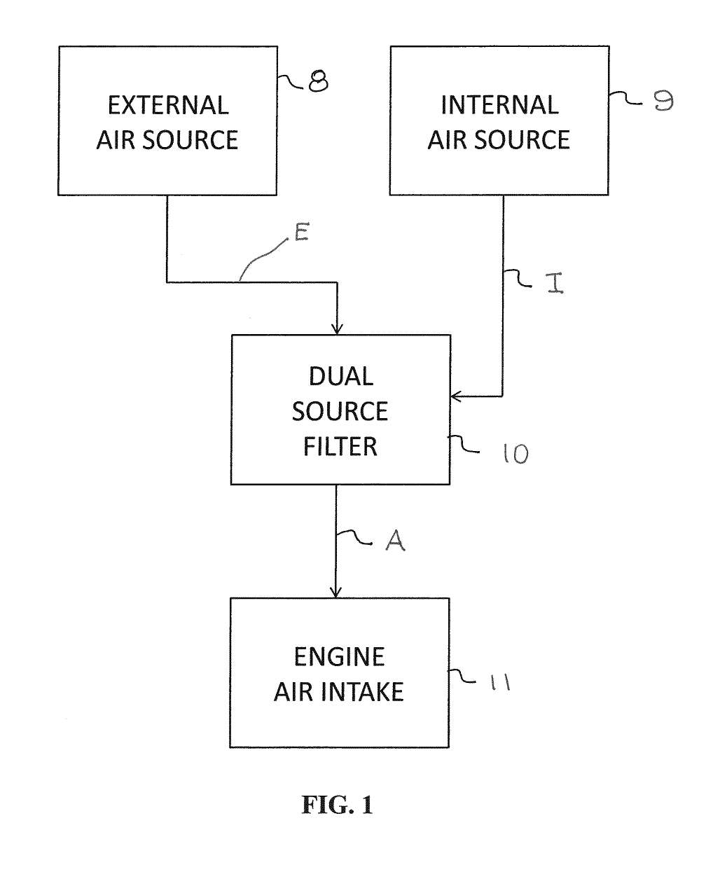

FIG. 1 is a flow diagram illustrating aspects of the present invention. A dual source filter 10 in accordance with an embodiment of the present invention is fed from an external air source 8 by a flow path E and an internal air source 9 by a flow path I. The dual source filter 10 includes an outer filter and an inner filter, as more fully described below. The external air source 8 draws in air E from outside of the vehicle. For example, the external air source 8 may be provided through a conventional fender opening found in OEM trucks and cars that are typically used to supply air to conventional automotive air filters. The internal air source 9 may draw in air I from the engine compartment of a vehicle. The external air source 8 thus draws in ambient air from outside of the vehicle, while the internal air source 9 draws in air from under the hood of the vehicle. The air flows E and I, from the external and internal sources 8 and 9 are combined in the dual source filter 10 and the combined air streams exit the filter as a mixed air stream A that is fed into the air intake system 11 of the vehicle engine.

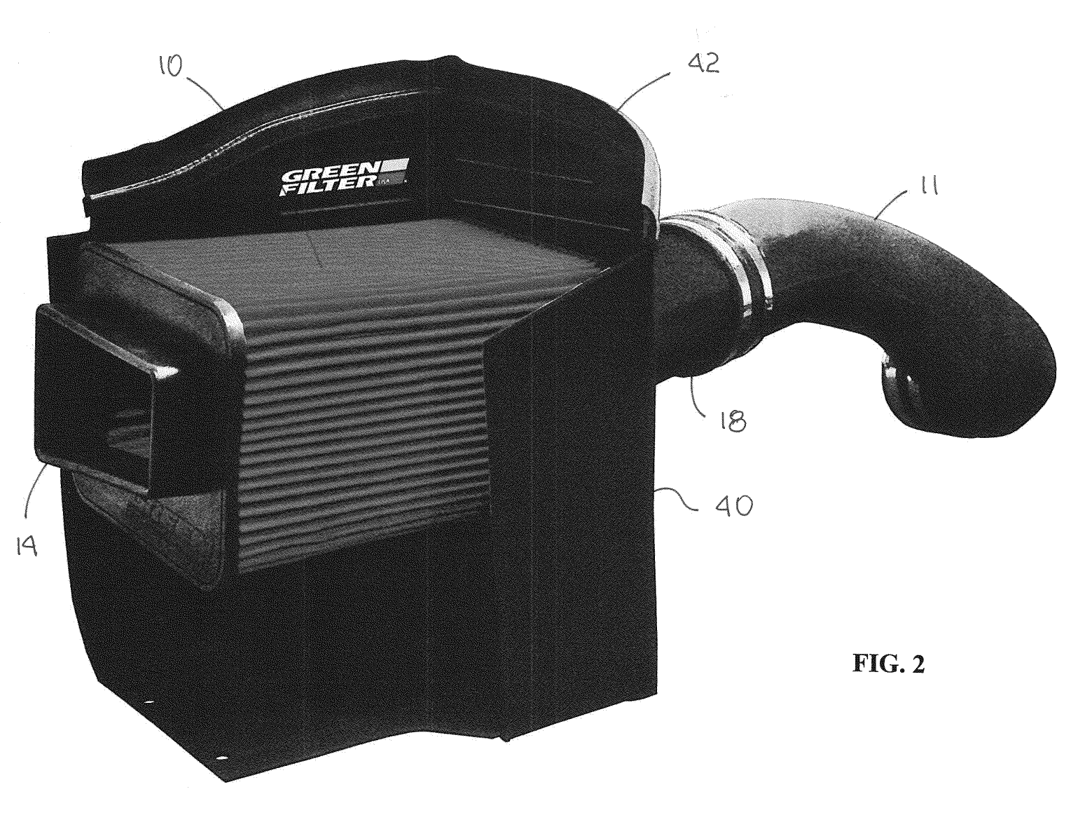

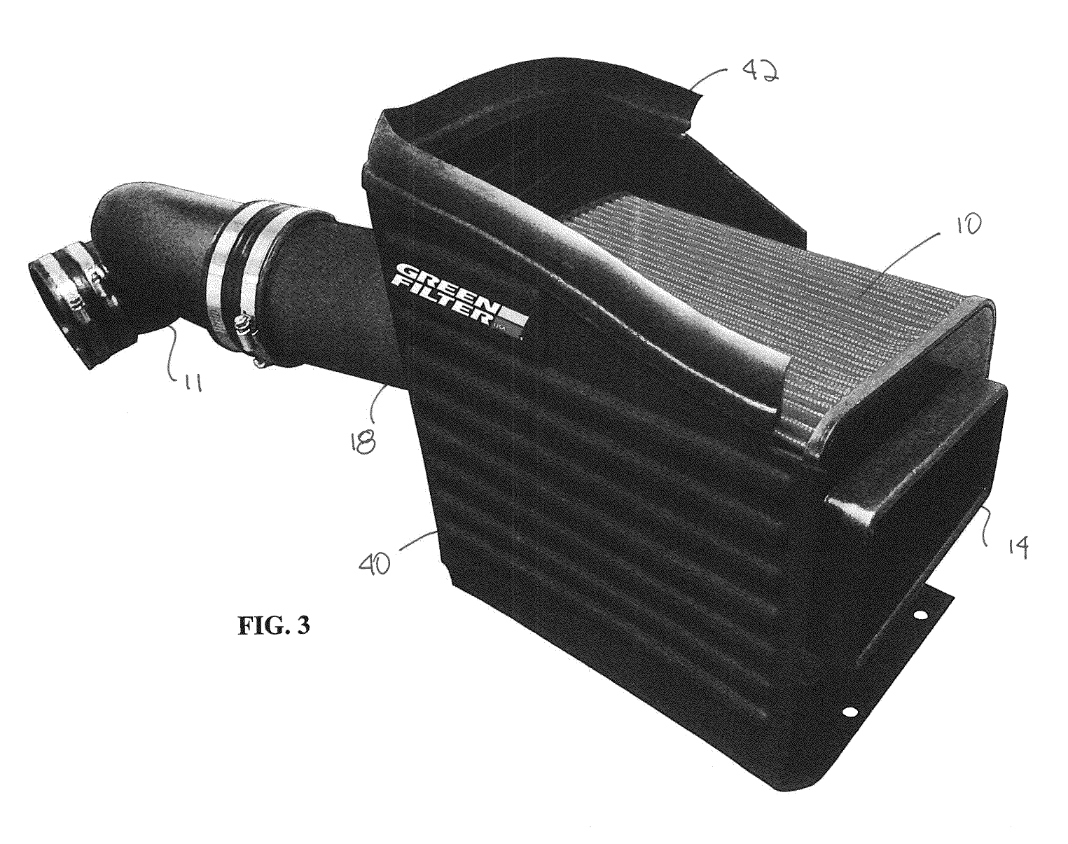

FIGS. 2 and 3 illustrate a dual air source automotive air filter system in accordance with an embodiment of the present invention. The system includes a dual source filter 10 installed within a housing 40 and connected to a delivery tube 11 for supplying filtered air to an engine (not shown). The housing 40 includes a flexible gasket 42 along its upper edge to provide a seal against the lower surface of a vehicle hood (not shown). During operation, although the housing 40 is at least partially sealed against the underside of the vehicle hood, a portion of the housing 40 remains open to the engine compartment to allow air contained within the engine compartment to enter the housing and to surround the exterior of the filter 10. As more fully described below, the dual source filter 10 includes an inlet such as a gasket, adapter or other type of seal that connects to the external air source to thereby feed relatively cold exterior air into the inner filter of the dual source filter 10.

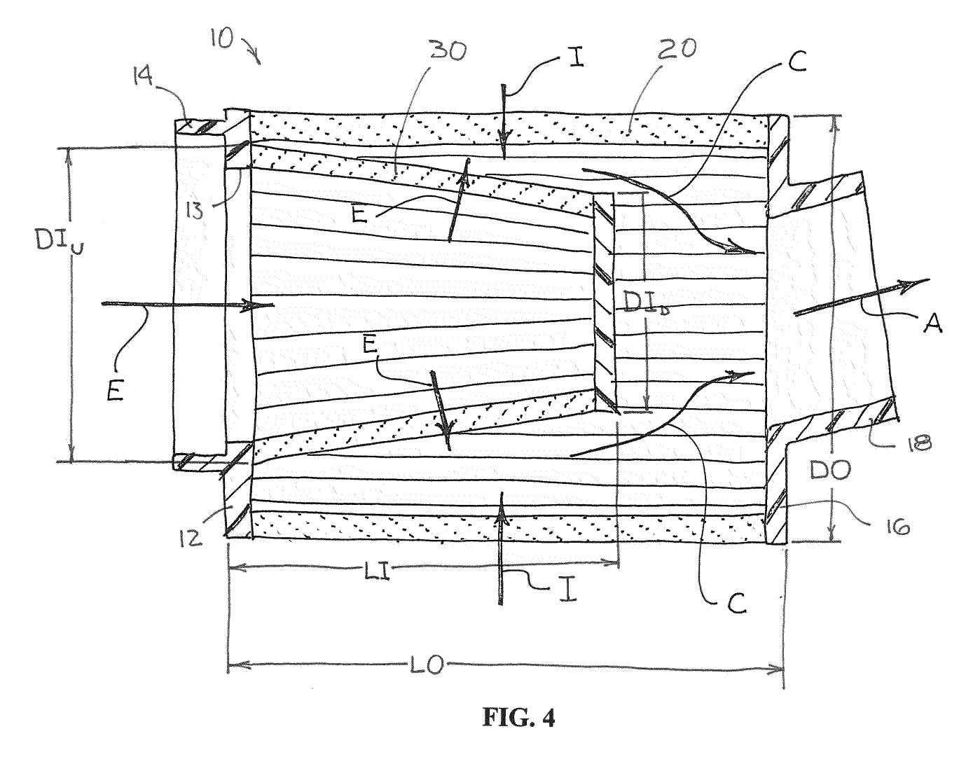

FIG. 4 is a partially schematic sectional view of a dual source filter 10 in accordance with an embodiment of the present invention. The dual source filter 10 includes an outer filter 20 and an inner filter 30. Air from the external air source E enters the filter 10 by passing into the interior of the inner filter 30, and then passing through the filter material of the inner filter 30 into the interior volume of the outer filter 20. In addition, air from the internal air source I passes into the dual source filter 10 by passing through the filter material of the outer filter 20 into the inner volume thereof. The external and internal air streams E and I are mixed to form a combined airstream C, which then exits the dual source filter 10 as the air supply A to the engine air intake system.

As shown in FIG. 4, the dual source filter 10 has a first end wall 12 and a second end wall 16. The first end wall 12 includes an opening 13 for allowing air from the external source E to enter the filter 10. A sealing gasket 14 extends from the first end 12, and is structured and arranged to fit into an OEM air intake structure, such as the fender opening of a particular type of truck or car. The second end wall 16 includes an outlet port 18 that allows filtered air A to travel from the dual source filter 10 to the engine air intake system 11 of a vehicle in which the dual source filter 10 is to be installed.

In the embodiment shown, the outer filter 20 is not substantially tapered, while the inner filter 30 has a slight taper angle. In certain embodiments, the cross-sectional shapes of the outer and inner filters 20 and 30 may be generally rectangular, circular, oval, or any other suitable shape. The filters 20 and 30 may be made of any suitable type of known filter material, such as the corrugated filters comprising cotton that are commercially available from Green Filter USA. The material of each filter 20 and 30 may have the same or different degree of air flow restriction. In certain embodiments, the outer filter material may have greater flow restriction than the inner filter. For example, the inner filter may consist of a two-layer high flow filter material having a relatively high cfm flow, while the outer filter may consist of a four-layer material having a relatively reduced cfm flow.

As shown in FIG. 4, the outer filter 20 has a length LO and a width or diameter DO. The inner filter 30 has a length LI, an upstream width or diameter DI_{U}, and a downstream width or diameter DI_{D}. The relative lengths of the outer filter LO and the inner filter LI may be selected to help achieve the desired ratio of internal air flow I and external air flow E that travels through the filter 10. In addition, the relative widths of the outer filter DO and inner filter DI_{U} and DI_{D}, as well as the taper angle of the inner filter, may be selected to help achieve the desired ratio of internal air flow I and external air flow E that travels through the filter.

In certain embodiments, the inner filter length LI is typically from 5 to 80 percent less than the outer filter length LO, for example, from 10 to 50 percent less. The downstream width DI_{D} of the inner filter may typically be from 5 to 80 percent less than its upstream width DI_{U}, for example, from 10 to 50 percent less. The downstream width DI_{D} of the inner filter 30 may typically be from 10 to 90 percent less than the width DO of the outer filter 20, for example, from 20 to 80 percent less.

A standard OEM automotive air filter system for a car or truck may be replaced with a dual air source filter system in accordance with an embodiment of the present invention. In a first step, the standard air filter system is removed, revealing the OEM fender opening conventionally used to draw in cool air from outside of the vehicle. A housing may then be installed in the vehicle engine compartment adjacent to the OEM fender air intake opening. Then, a dual air source filter in accordance with an embodiment of the present invention may be installed in the housing, with one end connected to the OEM fender air intake opening and another end connected to the engine air intake system of the vehicle.

Whereas particular embodiments of this invention have been described above for purposes of illustration, it will be evident to those skilled in the art that numerous variations of the details of the present invention may be made without departing from the invention as defined in the appended claims.

What is claimed is:

1. A dual source automotive air filter comprising:
an outer filter;
an inner filter at least partially inside the outer filter defining a combined airstream volume between an interior side of the outer filter and an exterior side of the inner filter;
an external air source inlet in flow communication with an interior volume of the inner filter; and
a combined airstream outlet in flow communication with the combined airstream volume.

2. The dual source automotive air filter of claim 1, wherein the inner filter is tapered inwardly from an inlet end thereof.

3. The dual source automotive air filter of claim 2, wherein the inner filter has an upstream width DI_{U} and a downstream width DI_{D}, and the downstream width DI_{D} is from 5 to 80 percent less than the upstream width DI_{U}.

4. The dual source automotive air filter of claim 3, wherein the downstream width DI_{D} is from 10 to 50 percent less than the upstream width DI_{U}.

5. The dual source automotive air filter of claim 1, wherein the outer filter has a substantially uniform width along a length thereof.

6. The dual source automotive air filter of claim 1, wherein the outer filter has a width DO, the inner filter has a downstream width DI_{D}, and the downstream width DI_{D} is from 10 to 90 percent less than the width DO of the outer filter.

7. The dual source automotive air filter of claim 6, wherein the downstream width DI_{D} is from 20 to 80 percent less than the width DO of the outer filter.

8. The dual source automotive air filter of claim 1, wherein the outer filter has a length LO, the inner filter has a length LI, and the length LI of the inner filter is from 5 to 80 percent less than the length LO of the outer filter.

9. The dual source automotive air filter of claim 8, wherein the length LI of the inner filter is from 10 to 50 percent less than the length LO of the outer filter.

10. The dual source automotive air filter of claim 1, wherein the inner filter comprises a sidewall made of filter material and an end wall made of a material impermeable to airflow.

11. The dual source automotive air filter of claim 1, wherein the outer and inner filters comprise different filter materials.

12. The dual source automotive air filter of claim 11, wherein the filter material of the outer filter has a greater flow restriction than the filter material of the inner filter.

13. The dual source automotive air filter of claim 12, wherein the filter material of the outer filter comprises at least two layers and the filter material of the inner filter comprises at least one layer less than the filter material of the outer filter.

14. A dual source automotive air filter system comprising:
a housing structured and arranged for installation in an engine compartment of an automotive vehicle; and
a dual source automotive air filter in the housing, comprising:
an outer filter having an exterior side exposed to air in the engine compartment when installed in the vehicle;
an inner filter at least partially inside the outer filter defining a combined airstream volume between an interior side of the outer filter and an exterior side of the inner filter;
an external air source inlet in flow communication with an interior volume of the inner filter; and
a combined airstream outlet in flow communication with the combined airstream volume.

15. The dual source automotive air filter system of claim 14, wherein the housing comprises an upper gasket structured and arranged to contact an engine hood of the vehicle.

16. The dual source automotive air filter system of claim 14, wherein the housing comprises at least one opening to allow flow communication between an exterior and an interior of the housing.

17. The dual source automotive air filter system of claim 14, wherein the housing is structured and arranged to at least partially seal against an engine hood of the vehicle, and to allow air flow between an exterior and an interior of the housing.

18. A method of installing a dual source automotive air filter system in an automotive vehicle comprising:
connecting an air inlet of the dual source air filter system to a source of external air drawn from outside an engine compartment of the vehicle; and
connecting an air outlet of the dual source air filter system to an engine air intake of the vehicle, wherein the dual source air filter system comprises:
a housing that is installed in the engine compartment of the vehicle; and
a dual source automotive air filter in the housing, comprising:
an outer filter having an exterior side exposed to air in the engine compartment; and
an inner filter at least partially inside the outer filter having an interior volume in flow communication with the source of external air.
